(19) United States
(12) Patent Application Publication
(10) Pub. No.: US 2021/0291977 A1
(43) Pub. Date: Sep. 23, 2021

(54) WING ROTATION STRUCTURE OF FLAPPING WING MICRO AIR VEHICLE

(71) Applicant: Tamkang University, NEW TAIPEI CITY (TW)

(72) Inventors: LUNG-JIEH YANG, NEW TAIPEI CITY (TW); SARAVANA KOMPALA, NEW TAIPEI CITY (TW)

(21) Appl. No.: 16/987,511

(22) Filed: Aug. 7, 2020

(30) Foreign Application Priority Data
Mar. 23, 2020 (TW) 109109658

(51) Int. Cl. B64C 33/02; B64C 39/02

(52) U.S. Cl. CPC B64C 33/02; B64C 39/028

(57) ABSTRACT

A wing rotation structure of a flapping wing micro air vehicle, for which, wing rotations are related to and caused by wing flappings, the wing rotation structure includes: an actuator mount, a left actuator, a right actuator, a left connector, a right connector, a left flapping wing arm, a right flapping wing arm, a central base, a left rotation bevel gear, a right rotation bevel gear, a left fixed auxiliary bevel gear, a right fixed auxiliary bevel gear. Wherein, the left actuator and the right actuator are located respectively on a left side and a right side of the actuator mount. the left connector connects the left actuator to the left flapping wing arm, and the right connector connects the right actuator to the right flapping wing arm. The central base is fixed securely on the actuator mount.

### BACKGROUND OF THE INVENTION

### Field of the Invention

The present invention relates to a wing rotation structure, and in particular to a wing rotation structure of flapping wing Micro Air Vehicles (MAV). In which, a pair of servo motors and a pair of bevel gears are designed, so that wing rotation structure of flapping wing Micro Air Vehicles (MAV) is capable of both wing flapping and wing rotation, in achieving greater lift and heavier load.

### The Prior Arts

The first flapping wing flying device was invented and designed by Leonardo da Vinci of Italy in the fifteenth century, and subsequently, through numerous innovations and improvements, the research of the flapping wing flying devices has been diversified into various fields. Along with the advance of miniaturization technology, scientists are keenly interested in imitating the wing flapping behaviors of birds, insects and bats during their flights, and that leads to the research and development of ornithopter. For the various ornithopters, their sizes are limited to a range of tens of millimeters. In this regard, the unmanned remote-control micro air vehicles (MAV) can be produced by making use of precision machines, and are used extensively in the fields of commerce, science, military, and are capable of performing various missions, such as rescue, surveillance, monitor, transport, and playing games.

In a Patent Case 1572526 of Taiwan is disclosed a “Flapping Wing Transmission Structure for MAV” (Prior Art 1). In which, an Evans linear structure is integrated into a five-bar linkage wing flapping structure. The Flapping Wing Transmission Structure mainly includes: a base, a speed reduction gear set, a pair of 5-bar linkage wing flapping structures, and a linear structure. Through effective integration of the linear structure and the 5-bar linkage wing flapping structure, the assembled structure is capable of fulfilling the requirement of large flapping angle, small phase difference, and small size, to be applicable to the micro air vehicle, while having vertical take off capability. However, this type of micro air vehicles (MAV) is only capable of wing flapping, while it is not capable of wing rotation. As such, it does not fully utilize the capability of flying objects provided by aerodynamics. Therefore, its lift is not sufficient, and improvements are required.

In this regard, in observing the flying process of birds or insects, scientists find out that in aerodynamics, the flight of insect can be explained by the interactions of three mechanisms: delayed stall, wing rotation, and wake capture. Wherein, wing rotations of flying wing are able to increase the flying lift of birds or insects. Further, through observing the flying behaviors of birds or insects in an experiment, it is learned that, between up-flapping and down-flapping of a wing, wing rotations are performed. Namely, when the wing is flapped upward to a top position, and before the wing is flapped downward, wing rotation is performed. Similarly, when the wing is flapped downward to a bottom position, and before the wing is flapped upward, another wing rotation is performed, and the two wing rotations are symmetric. The wing rotations thus produced could generate vortexes, to increase the lift of the birds or insects, and raise their flying capability.

In the existing technology, the design of the wing flapping micro air vehicle is focused on flapping wings upward and downward. As such, it has the drawback of neglecting some of the important aerodynamic effects, such as wing rotations. To redress this problem, the Applicant of the present case proposed “A wing flapping and wing rotation type micro air vehicle (MAV) having servo motors” (Prior Art 2). This type of micro air vehicle (MAV) is provided with two pairs of servo motors, wherein one pair is used to perform and control wing flapping, while the other pair is used to perform and control wing rotation, to raise its lift when flying. Refer to FIG. 1 for a perspective view of a wing flapping and wing rotation type micro air vehicle (MAV) having servo motors according to Prior Art 2. As shown in FIG. 1, the flying vehicle 30 includes a fuselage 31, a wing 32, a tail 33, a first servo motor 34, a second servo motor 35, a third servo motor 36, and a fourth servo motor 37. The second pair of the third servo motor 36 and the fourth servo motor 37 are used to generate and control wing flapping, and the first pair of the first servo motor 34 and the second servo motor 35 are used to generate and control wing rotations. Through wing flapping and rotations, the lift for the micro air vehicle can be increased significant while flying. However, the shortcoming of this kind of design is that, the servo motor is rather heavy, the use of two pairs of servo motors (totaling 4 servo motors) could cause the problem of overweight, and that is unfavorable to the flight of micro air vehicle.

Therefore, presently, the design and performance of micro air vehicle (MAV) is not quite satisfactory, and it leaves much room for improvements.

### SUMMARY OF THE INVENTION

In view of the problems and drawbacks of the Prior Arts, the present invention provides a wing rotation structure of flapping wing Micro Air Vehicles (MAV), to overcome the shortcomings of the Prior Art.

The present invention provides a wing rotation structure of a flapping wing micro air vehicle, for which, wing rotations are related to and caused by wing flapping. The wing rotation structure includes: an actuator mount, a left actuator, a right actuator, a left connector, a right connector, a left flapping wing arm, a right flapping wing arm, a central base, a left rotation bevel gear, a right rotation bevel gear, a left fixed auxiliary bevel gear, a right fixed auxiliary bevel gear.

Wherein, the left actuator and the right actuator are located respectively on a left side and a right side of the actuator mount, and are used to actuate wing flapping. The left connector connects the left actuator to the left flapping wing arm, and the right connector connects the right actuator to the right flapping wing arm. The central base is fixed securely on the actuator mount, the left fixed auxiliary bevel gear and the right fixed auxiliary bevel gear are fixed securely on an outward facing left side and an outward facing right side of the central base respectively. The left rotation bevel gear is disposed in a wing rotation slot of the left flapping wing arm, and the right rotation bevel gear is disposed in a wing rotation slot of the right flapping wing arm.

The left rotation bevel gear and the right rotation bevel gear are engaged respectively with the left fixed auxiliary bevel gear and the right fixed auxiliary bevel gear.

A wing flapping set is inserted in an axial hole of the left rotation bevel gear and an axial hole of the right rotation bevel gear respectively, such that the left fixed auxiliary bevel gear and the right fixed auxiliary bevel gear are arranged coaxially with the left actuator and the right actuator respectively.

In operation, after power is supplied, the left actuator and the right actuator are actuated. The left connector and the right connector are connected to the left actuator and the right actuator respectively to perform driving and rotation, to bring the left flapping wing arm and the right flapping wing arm into flapping synchronously, such that the left rotation bevel gear and the right rotation bevel gear are brought into flapping along with the left flapping wing arm and the right flapping wing arm respectively. Since the left fixed auxiliary bevel gear and the right fixed auxiliary bevel gear are engaged respectively with the left rotation bevel gear and the right rotation bevel gear, so that left rotation bevel gear and the right rotation bevel gear are brought to move in two dimensions, in achieving wing flapping and wing rotation.

Through controlling rotations of the left actuator and the right actuator, wing flapping and wing rotation of the wing flapping set can be controlled. Further, through varying the total engaged teeth number for engaging the left rotation bevel gear and the right rotation bevel gear with the left fixed auxiliary bevel gear and the right fixed auxiliary bevel gear respectively, wing rotations of the wing flapping set can be controlled.

The wing rotation structure of the flapping wing micro air vehicle is made through using CAD software design, 3D printing technology, and Zortax ASA (acrylonitrile styrene acrylate)-pro material.

The size of the wing rotation structure of the flapping wing micro air vehicle is: length 85 mm, width 63 mm, height 39.3 mm, and having weight 47 gram, wing flapping frequency 3.1 Hz, and maximum lift of 91-gram force (gf).

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed descriptions of the present invention to be made later are described briefly as follows, in which:

FIG. 1 is a perspective view of a wing flapping and wing rotation type micro air vehicle (MAV) having servo motors according to Prior Art 2;

FIG. 2 is an exploded view of a wing rotation structure of a flapping wing Micro Air Vehicles (MAV) according to the present invention;

FIG. 3 is an assembled view of a wing rotation structure of a flapping wing Micro Air Vehicles (MAV) according to the present invention;

FIG. 4 is a top view of a wing rotation structure of a flapping wing Micro Air Vehicles (MAV) according to the present invention;

FIG. 5 is a front view of a wing rotation structure of a flapping wing Micro Air Vehicles (MAV) according to the present invention;

FIG. 6 is a rear view of a wing rotation structure of a flapping wing Micro Air Vehicles (MAV) according to the present invention;

FIG. 7 is a left side view of wing rotation structure of flapping wing Micro Air Vehicles (MAV) according to the present invention;

FIG. 8 is a right side view of wing rotation structure of flapping wing Micro Air Vehicles (MAV) according to the present invention; and

FIG. 9 is a schematic diagram of a wing flapping and wing rotation Micro Air Vehicles (MAV) formed by assembling the wing rotation structure of flapping wing Micro Air Vehicles (MAV) and a wing flapping set together according to the present invention.

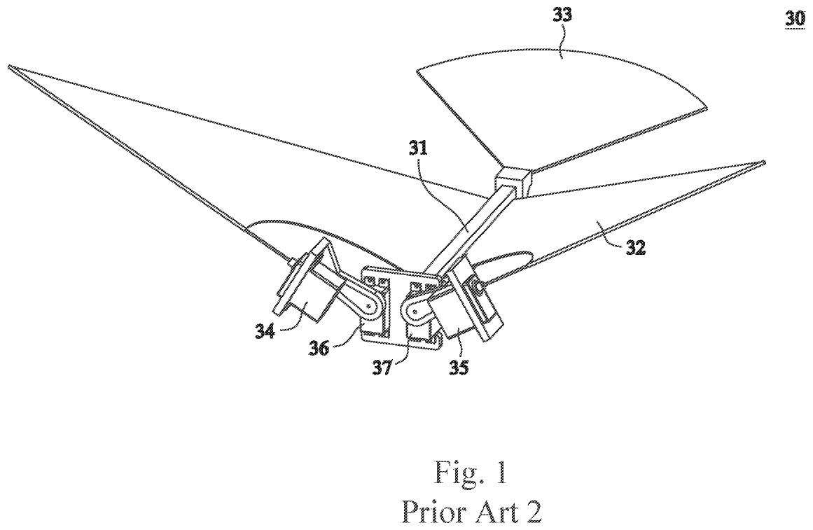

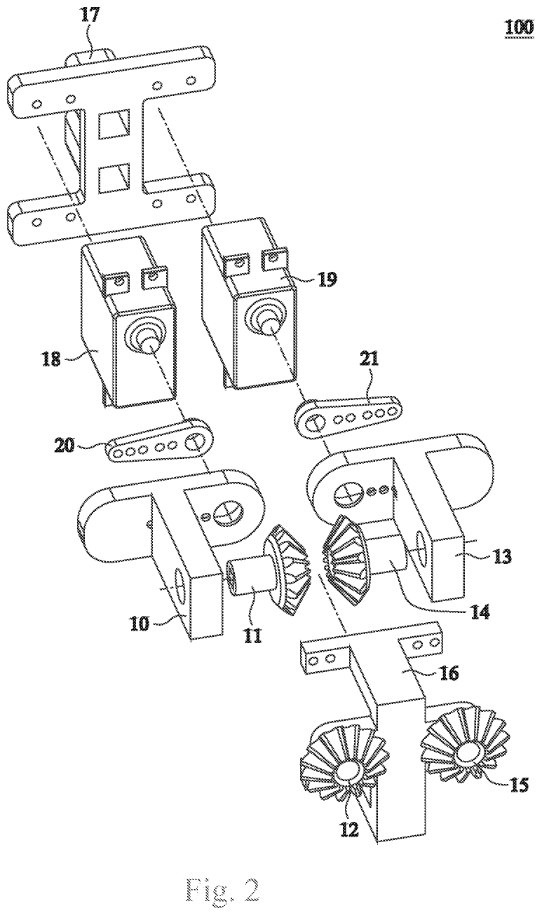

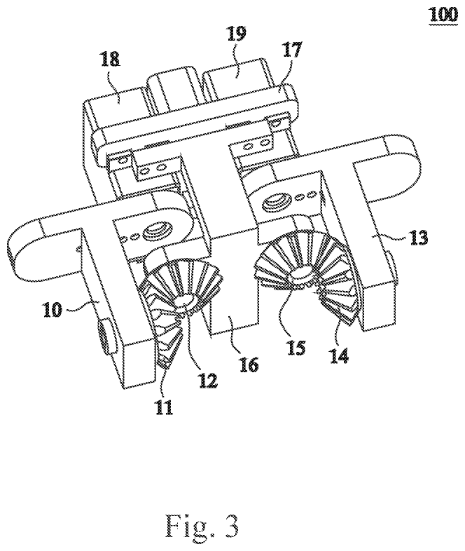

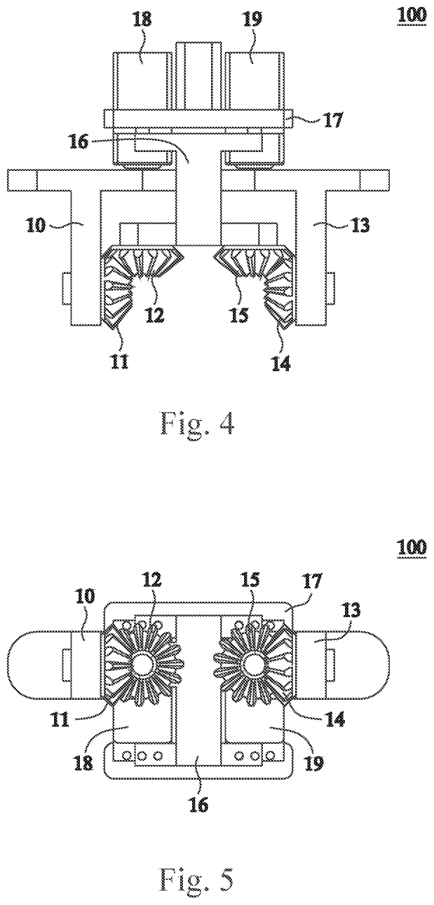

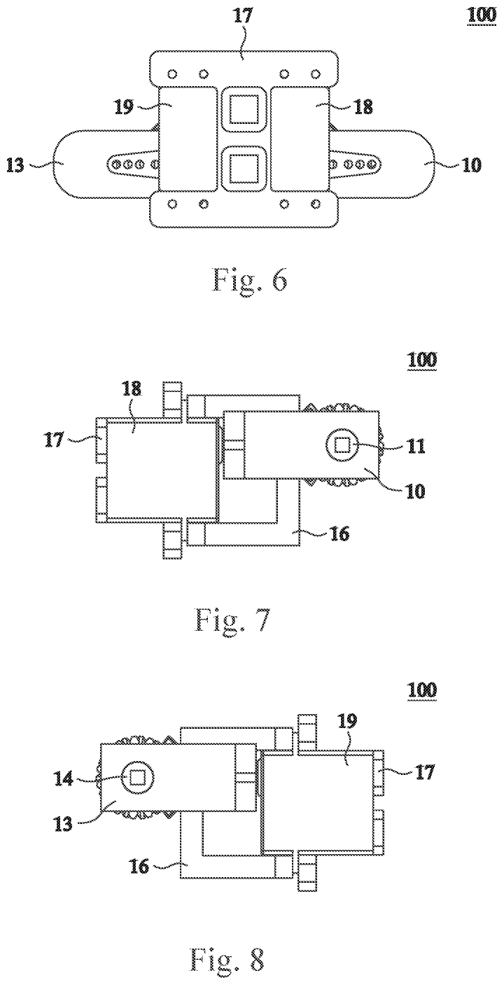

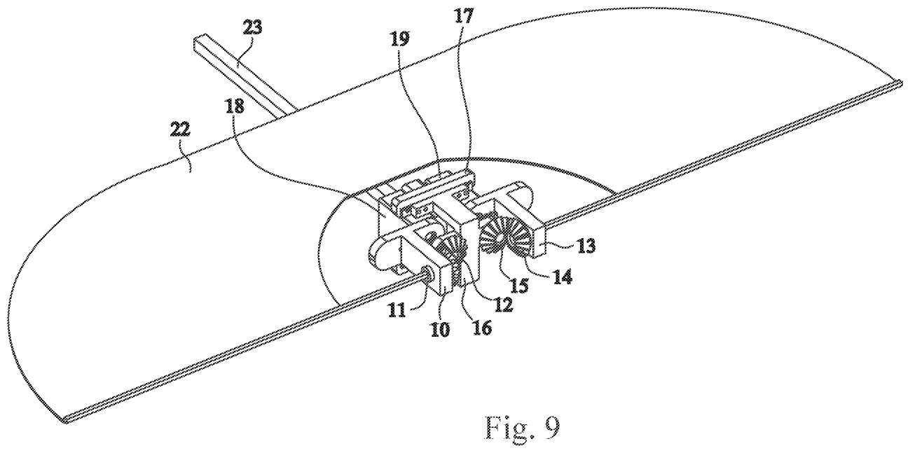

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

In the following, an embodiment is used to describe the various details of the present invention. However, it does not mean that this embodiment represents all the embodiments of the present invention. Other embodiments can be envisaged by people familiar with this field, and thus they all fall into the scope of the present invention.

The present invention provides a wing rotation structure of a flapping wing micro air vehicle (MAV), for which, wing rotations are related to and caused by wing flappings. The wing rotation structure 100 includes: an actuator mount 17, a left actuator 18, a right actuator 19, a left connector 20, a right connector 21, a left flapping wing arm 10, a right flapping wing arm 13, a central base 16, a left rotation bevel gear 11, a right rotation bevel gear 14, a left fixed auxiliary bevel gear 12, a right fixed auxiliary bevel gear 15.

Wherein, two-ear shape protrusion plates of the left actuator 18 and the right actuator 19 are located respectively on a left side and a right side of the actuator mount 17, and are used to actuate wing flapping. The left connector 20 connects the rotation axle of the left actuator 18 to the left flapping wing arm 10, and the right connector 21 connects the rotation axle of the right actuator 19 to the right flapping wing arm 13. The central base 16 together with the left fixed auxiliary bevel gear 12 and the right fixed auxiliary bevel gear 15, are fixed securely on the actuator mount 17 assembled with the left actuator 18 and the right actuator 19. The left fixed auxiliary bevel gear 12 and the right fixed auxiliary bevel gear 15 are fixed securely on an outward facing left side and an outward facing right side of the central base 16 respectively. Finally, the left rotation bevel gear 11 is disposed in a wing rotation slot of the left flapping wing arm 10, and the right rotation bevel gear 14 is disposed in a wing rotation slot of the right flapping wing arm 13.

The left rotation bevel gear 11 and the right rotation bevel gear 14 are engaged respectively with the left fixed auxiliary bevel gear 12 and the right fixed auxiliary bevel gear 15.

A wing flapping set 22 is inserted in an axle hole of the left rotation bevel gear 11 and an axial hole of the right rotation bevel gear 14 respectively, such that the left fixed auxiliary bevel gear 12 and the right fixed auxiliary bevel gear 15 are arranged coaxially with the left actuator 18 and the right actuator 19 respectively.

In operation, after power is supplied, the left actuator 18 and the right actuator 19 are actuated, and the left connector 20 and the right connector 21 are connected to the left actuator 18 and the right actuator 19 respectively, to perform driving and rotation. As such, bringing the left flapping wing arm 10 and the right flapping wing arm 13 into flapping synchronously, such that the left rotation bevel gear 11 and the right rotation bevel gear 14 are brought into flapping along with the left flapping wing arm 10 and the right flapping wing arm 13 respectively. Since the left fixed auxiliary bevel gear 12 and the right fixed auxiliary bevel gear 15 are engaged respectively with the left rotation bevel gear 11 and the right rotation bevel gear 14, so the left rotation bevel gear 11 and the right rotation bevel gear 14 are brought to move in two dimensions, in achieving wing flappings and wing rotations.

Through controlling rotations of the left actuator 18 and the right actuator 19, wing flapping and wing rotation of the wing flapping set 22 can be controlled. And through varying the total engaged teeth number for engaging the left rotation bevel gear 11 and the right rotation bevel gear 14 with the left fixed auxiliary bevel gear 12 and the right fixed auxiliary bevel gear 15 respectively, the wing rotations of the wing flapping set 22 can be controlled.

In addition, through varying the total engaged teeth number for engaging the left rotation bevel gear 11 and the right rotation bevel gear 14 with the left fixed auxiliary bevel gear 12 and the right fixed auxiliary bevel gear 15 respectively, and through controlling the wing flapping angle caused by the actuators 18 and 19, the wing rotation angle can be controlled.

The wing rotation structure of the flapping wing micro air vehicle 100 can be made through using CAD software design, 3D printing technology, and Zortax ASA (acrylonitrile styrene acrylate)-pro material. In assembling the wing rotation structure of the present invention into a micro air vehicle, a carbon fiber rod having cross section 6 mm×6 mm can be used as a fuselage 23 of the micro air vehicle. In addition, a carbon fiber rod having cross section 3 mm×3 mm can be used as the wing spar. In the present invention, the actuator can be a servo motor.

In the present invention, the tests and verifications for various parameters and functions are conducted in a wind tunnel. In the wind tunnel, high speed cameras are provided to obtain data/information such as wing flapping frequency, wing flapping angle, and wing rotation angle.

In application, the wing rotation structure of the flapping wing micro air vehicle can be made into a size of length 85 mm, width 63 mm, and height 39.3 mm, and having a weight of 47 grams, wing flapping frequency 3.1 Hz, and maximum lift 91-gram force (gf).

In the rear side of the present invention, a Lithium polymer (LiPo) battery (not shown) connected to the actuators can be provided, to supply the power required.

In a micro air vehicle making use of the wing rotation structure of the present invention, a fuselage 23 can be provided, that is made of a carbon fiber rod to reduce weight. Further, the wing flapping set 22 can be made of a polyethylend terephthalate (PET) film.

In the following, refer to Tables 1 and 2 to explain that the functions of the present invention is indeed superior to the Prior Arts 1 and 2, and the present invention is able to achieve the effects that can not be attained by the Prior Arts 1 and 2, thus fulfilling the requirements of inventiveness.

Firstly, the functions and effects of the present invention are better than the Prior Art 1, and the reasons are as mentioned earlier in that, it is only capable of wing flapping but not wing rotation, so that its lift is insufficient for flying. In contrast, the present invention fully utilizes the capability provided by aerodynamics, such that it is capable of wing flapping and wing rotation, to increase the lift significantly during its flight.

Secondly, the functions and effects of the present invention are better than the Prior Art 2, such that it is able to achieve the effects that can not be attained by the Prior Art 2, thus fulfilling the requirements of inventiveness as explained as follows:

1. Prior Art 2 utilizes two pairs of servo motors (totaling 4 units), with one pair used for wing flapping, and with the other pair used for wing rotation, therefore, the total weight is 13.4×4=53.6 grams. The present invention utilizes one pair of actuators (servo motors) and a pair of bevel gears, having a total weight of 13.4×2+1.02×2=26.8+2.04=28.84 grams, that is almost only one half of weight of the Prior Art 2. Therefore, the total weight of the present invention (47 grams) is only 56% of the weight of the Prior Art 2 (83 grams), thus reducing the power required during its flight. In the condition of using the same kind of battery power source, the present invention is able to have better endurance of flight, in achieving longer flying time and flying distance.

2. Compared with the Prior Art 2, the present invention can be made lighter, and having smaller volume (length, width, height), thus being able to reduce the material utilized, reduce the production cost, while occupying less space.

3. In the present invention, the maximum average lift/weight=91 gf/47 gm=1.94 gf/gm; while in the Prior Art 2 the maximum average lift/weight=133 gf/83 gm=1.6 gf/gm. Therefore, for the present invention, the average lift/weight can be raised by (1.94−1.6)/1.6=21.25%. In case the average lift/weight of the present invention is used for the Prior Art 2, that could raise its lift by 83 gm×(1.94-1.6)=28.22 gf. As such, the present invention is able to provide greater lift, to carry heavier load when flying.

4. The present invention makes use of a pair of actuators (servo motors), while the Prior Art 2 utilizes two pairs of servo motors, therefore in application, the latter could produce greater vibrations and noises, be liable to be detected by the enemy.

5. When the wing rotation structure of the present invention is mounted on a micro air vehicle, the ratio of its wing span as compared with that of the Prior Art 2 is 650 mm vs 960 mm; while the ratio of flapping wing areas between the two cases is 108,480 mm² vs 254,100 mm². The reasons for the scales of these ratios are that, the micro air vehicle of the Prior Art 2 is much heavier, and according to the scaling law for a flying object, it needs larger wing span and larger flapping wing area to carry on flying. In the present invention, the micro air vehicle formed by wing rotation structure is lighter in weight, and it is able to achieve greater flight endurance capability. Therefore, in addition to the benefit of reducing material used and saving cost, it has the advantages of being less likely to be detected by the enemy while carrying on reconnaissance missions.

TABLE 1
Comparisons of component weights
for the present case vs Prior Art 2

| | Prior art 2 | present case |
|---|---|---|
| Mechanism parts | (grams) | (grams) |
| Servo motor each | 13.4 * 4 = 53.6 | 13.4 * 2 = 26.8 |
| 13.4 grams | | |
| Left Flapping arms | 6.46 | 3.09 |
| Right flapping arm | 6.46 | 3.09 |
| Left Rotating Servo | 6.28 | — |
| motor to wing | | |
| spar attacher | | |
| Right Rotating Servo | 6.28 | — |
| motor to wing | | |
| spar attacher | | |
| Central base along with | — | 7.2 |
| fixed bevel gears | | |
| Left Rotational | — | 1.02 |
| bevel gears | | |
| Right Rotational | — | 1.02 |
| bevel gears | | |
| Actuator mount | 4.1 | 4.1 |
| Total | 83.18 | 46.32 |

TABLE 2
Comparisons of parameters for the present case vs Prior Art 2

| Parameters | Prior art 2 | | Present case | |
|---|---|---|---|---|
| Length | 157.6 | mm | 85 | mm |
| Width | 46.5 | mm | 63 | mm |
| Height | 42.7 | mm | 39.3 | mm |
| Weight of mechanism | 83 | grams | 47 | grams |
| Wing flapping frequency | 1.4 Hz | at 2.2 V | 1.4 Hz | at 2.2 V |
| | 1.6 Hz | at 5.5 V | 2 Hz | at 5.5 V |
| | 2.7 Hz | at 8.8 V | 3.1 Hz | at 8.8 V |
| Maximum flapping angle | 127° | at 2.2 V | 110° | at 2.2 V |
| | 102° | at 5.5 V | 85° | at 5.5 V |
| | 62° | at 8.8 V | 60° | at 8.8 V |
| Wing rotation angle | ~120° | at 2.2 V | ~108° | at 2.2 V |
| | ~101° | at 5.5 V | ~82° | at 5.5 V |
| | ~62° | at 8.8 V | ~57° | at 8.8 V |
| Wing Span | 960 | mm | 650 | mm |
| Total weight including | 121 | grams | 74 | grams |
| wing set | | | | |
| Chord length | 296.5 | mm | 215 | mm |
| Wing area | 254100 | mm² | 108480 | mm² |

| | | | |
|---|---|---|---|
| Maximum average lift | 133 | gf | 91 gf (Less because of |
| | | | smaller wing span, mean |
| | | | chord, and wing area) |

Summing up the above, the functions and performances of the present invention is superior to that of the Prior Arts, and it can achieve the merits and effects not anticipated by the Prior Arts 1, 2, therefore the present invention does fulfill the requirements of inventiveness.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A wing rotation structure of a flapping wing micro air vehicle, for which, wing rotations are related to and caused by wing flappings, the wing rotation structure includes:
an actuator mount, a left actuator, a right actuator, a left connector, a right connector, a left flapping wing arm, a right flapping wing arm, a central base, a left rotation bevel gear, a right rotation bevel gear, a left fixed auxiliary bevel gear, and a right fixed auxiliary bevel gear, wherein
the left actuator and the right actuator are located respectively on a left side and a right side of the actuator mount, and are used to actuate wing flapping, the left connector connects the left actuator to the left flapping wing arm, and the right connector connects the right actuator to the right flapping wing arm, the central base is fixed securely on the actuator mount, the left fixed auxiliary bevel gear and the right fixed auxiliary bevel gear are fixed securely on an outward facing left side and an outward facing right side of the central base respectively, the left rotation bevel gear is disposed in a wing rotation slot of the left flapping wing arm, and the right rotation bevel gear is disposed in a wing rotation slot of the right flapping wing arm.

2. The wing rotation structure of the flapping wing micro air vehicle as claimed in claim 1, wherein the left rotation bevel gear and the right rotation bevel gear are engaged respectively with the left fixed auxiliary bevel gear and the right fixed auxiliary bevel gear.

3. The wing rotation structure of the flapping wing micro air vehicle as claimed in claim 1, wherein a wing flapping set is inserted in an axle hole of the left rotation bevel gear and in an axle hole of the right rotation bevel gear respectively, such that the left fixed auxiliary bevel gear and the right fixed auxiliary bevel gear are arranged coaxially with the left actuator and the right actuator respectively.

4. The wing rotation structure of the flapping wing micro air vehicle as claimed in claim 1, wherein in operation, after power is supplied, the left actuator and the right actuator are actuated, and the left connector and the right connector are connected to the left actuator and the right actuator respectively to perform driving and rotations, to bring the left flapping wing arm and the right flapping wing arm into flapping synchronously, such that the left rotation bevel gear and the right rotation bevel gear are brought into flapping along with the left flapping wing arm and the right flapping wing arm respectively, since the left fixed auxiliary bevel gear and the right fixed auxiliary bevel gear are engaged respectively with the left rotation bevel gear and the right rotation bevel gear, so that left rotation bevel gear and the right rotation bevel gear are brought to move in two dimensions, in achieving wing flappings and wing rotations,

5. The wing rotation structure of the flapping wing micro air vehicle as claimed in claim 1, wherein through controlling rotations of the left actuator and the right actuator, wing flapping and wing rotation of the wing flapping set are controlled; and through varying a total engaged teeth number for engaging the left rotation bevel gear and the right rotation bevel gear with the left fixed auxiliary bevel gear and the right fixed auxiliary bevel gear respectively, and through controlling a wing flapping angle caused by the actuators, control of a wing rotation angle is achieved.

6. The wing rotation structure of the flapping wing micro air vehicle as claimed in claim 1, wherein the wing rotation structure of the flapping wing micro air vehicle is made through using a CAD software design, a 3D printing technology, and Zortax ASA (acrylonitrile styrene acrylate)-pro material.

7. The wing rotation structure of the flapping wing micro air vehicle as claimed in claim 1, wherein sizes of the wing rotation structure of the flapping wing micro air vehicle are: length 85 mm, width 63 mm, height 39.3 mm, and having a weight of 47 gram, wing flapping frequency 3.1 Hz, and maximum lift 91 gram force (gf).
